(19) United States
(12) Patent Application Publication
(10) Pub. No.: US 2001/0055094 A1
(43) Pub. Date: Dec. 27, 2001

(54) Holographic ophthalmic lens

(76) Inventor: Xiaoxiao Zhang, Suwanee, GA (US)

Correspondence Address: THOMAS HOXIE, NOVARTIS CORPORATION, PATENT AND TRADEMARK DEPT, 564 MORRIS AVENUE, SUMMIT, NJ, 079011027

(21) Appl. No.: 09/918,339

(22) Filed: Jul. 30, 2001

Related U.S. Application Data
(62) Division of application No. 09/196,540, filed on Nov. 20, 1998.

(51) Int. Cl. G02C 7/02

(52) U.S. Cl. 351/159; 351/177

(57) ABSTRACT

The invention provides a method for producing a corrective optical lens. The method has the steps of introducing a polymerizable optical material in a mold for an ophthalmic lens, or a holographic recording medium; and exposing the polymerizable material in the mold or the recording medium to electromagnetic waves, wherein the electromagnetic waves form a pattern of interference fringes while polymerizing the polymerizable material or while exposing the recording medium, thereby the pattern is recorded in the lens to form a volume grating structure, thereby forming a volume holographic element, wherein the pattern diffracts light entering said front curve to correct the ametropic conditions when placed on, in or in front of an eye.

### BACKGROUND OF THE INVENTION

The present invention relates to an ophthalmic lens containing a holographic element and a method for producing the ophthalmic lens.

Ophthalmic lenses, e.g., contact lenses and intraocular lenses, for correcting ametropia and other adverse vision conditions using the refractive power of optically clear polymers are widely available. Ametropia is the term that indicates any condition of refractive visual impairment of the eye, including myopia, hyperopia, prebyopia and astigmatism. Because each ametropic condition requires a specific measure, i.e., a specific corrective power, there need to be a large number of different designs for ophthalmic lenses to accommodate many different visual defects of the eye. For example, just to accommodate different levels of myopic conditions with contact lenses, a range of different single-power contact lenses having from 0 to −10 diopters or even lower, in quarter diopter increments, are produced. Consequently, almost a myriad of different contact lenses having different corrective measures need to be designed and produced if every ametropic condition is to be accommodated. The current approach to this accommodation problem is mass producing ophthalmic lenses for common ametropic conditions and then custom manufacturing ophthalmic lenses for uncommon ametropic conditions. However, the current approach does not eliminate the need for designing and producing a large number of ophthalmic lenses having different corrective measures. In addition, the current approach requires a large inventory of stock keeping units of ophthalmic lenses to be carried by lens manufacturers and practitioners in order to accommodate a wide variety of different ametropic conditions.

Conventional production methods for producing ophthalmic lenses include lathe cutting methods and cast molding methods. A lathe cutting method produces an ophthalmic lens by cutting a solid substrate of a polymeric optical material to a designed shape. Such method is highly suitable for custom producing relatively small-volume specialty ophthalmic lenses. However, the lathe cutting method has many disadvantages. For example, it is a labor-intensive process.

A cast molding method uses a mold to produce an ophthalmic lens. Typically, a lens mold has two mold halves—a front curve mold half and a back curve mold half A polymerizable liquid composition is introduced into the front curve mold half, and the back curve mold half is placed over the front curve mold half, closing the mold. Then the polymerizable composition in the mold is thermo- or photo-polymerized to form a solid ophthalmic lens. This method is highly useful for producing a large volume of relatively simple lenses. However, the cast molding method also has disadvantages. For example, the method requires that specific lens mold halves be designed and produced for each ametropic condition and each corrective power. Therefore, a large number of lens molds for different corrective conditions and powers must be produced and carried as an inventory to accommodate even just common ametropic conditions.

Additionally, the design limitations of conventional refractive ophthalmic lenses, which rely on the thickness variations of the lenses to provide varying corrective powers, do not allow the ophthalmic lens design to be optimized solely for the comfort of the lens wearer.

There remains a need for a corrective ophthalmic lens that does not have the disadvantages of prior art ophthalmic lenses and can be produced by a simpler production process than the conventional ophthalmic lens production processes.

### SUMMARY OF THE INVENTION

There is provided in accordance with the present invention, a flexible method for producing optical lenses, more desirably ophthalmic lenses, having a wide range of different powers for correcting diverse ametropic conditions, and lenses produced by the method. The method for producing an optical lens for correcting an ametropia of an eye includes the steps of introducing a polymerizable optical material in a mold for an ophthalmic lens, exposing the polymerizable material in the mold to electromagnetic waves, wherein the electromagnetic waves form a pattern of refractive index modulation in the polymerizable material while polymerizing the same, wherein the pattern modifies light entering the lens to correct the ametropic conditions. The term “optical lenses” as used herein indicates both ophthalmic lenses and spectacle lenses, unless otherwise indicated.

Additionally provided is a method for producing an optical lens for correcting ametropic conditions, which method includes the steps of exposing a holographic recording medium to electromagnetic waves, wherein the electromagnetic waves form a permanent pattern of refractive index modulation and the pattern is designed to diffract light entering the lens at least partially to correct the ametropia, developing the exposed holographic recording medium, and encapsulating the developed recording medium in a biocompatible optical material, thereby forming the optical lens.

The lenses produced by the methods of the present invention provides corrective powers for various ametropic conditions, including myopia, hyperopia, presbyopia and combinations thereof, and the lenses are designed to be used on, in or in front of a mammalian eye, more particularly a human eye. Additionally, the lens can be programmed to provide a wide variety of corrrective powers, e.g., between +10 diopters and −20 diopters, without changing the dimensions, e.g., thickness, of the lens.

### DESCRIPTION OF THE DRAWING

FIG. 1 illustrates a corrective ophthalmic lens of the present invention.

FIG. 2 illustrates a method for producing a volume holographic optical element of the present invention.

FIGS. 3-3B illustrates a combination holographic optical element.

### DETAILED DESCRIPTION OF THE INVENTION

The present invention provides a method for producing ophthalmic lenses and lenses produced by the method. The method is highly flexible such that a wide range of lenses having many different corrective powers and combinations of corrective powers can be produced, and the lenses produced by the method are highly suitable for correcting various ametropic conditions. Exemplary ametropic conditions that can be corrected with the present lens include myopia, hyperopia, presbyopia, regular and irregular astigmatisms and combinations thereof In accordance with the present invention, the corrective ophthalmic lens is produced by programming in a corrective power in an optical lens material, and not by varying the dimensions of the lens, although dimensions of the lens can be varied to provide an additional or supplemental power. Unlike conventional corrective ophthalmic lenses, the ophthalmic lens of the present invention does not rely or substantially rely on the changes in the dimensions, e.g., the thickness of the optical zone, of an ophthalmic lens to correct ametropic conditions. Consequently, a lens design that maximizes the comfort of the lens wearer can be used to correct many different ametropic conditions, without the dimensional design constraints of convention refractive lenses.

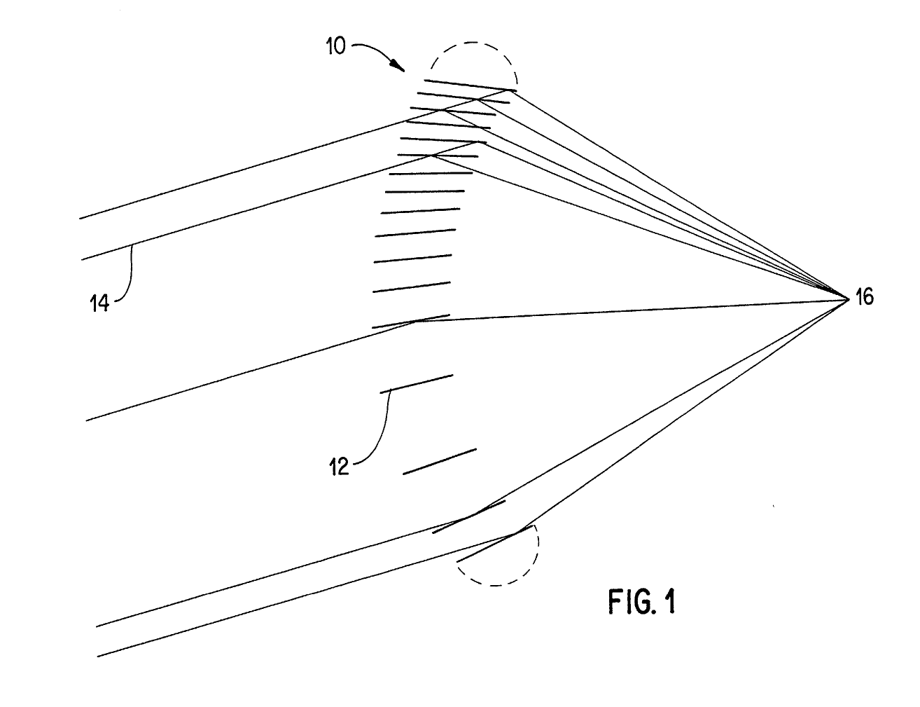

The ophthalmic lens of the present invention utilizes the diffractive property of a holographic optical element (HOE), more particularly a transmission volume HOE, to provide a corrective power. The volume HOE of the present invention contains interference fringe patterns that are programmed or recorded as a periodic variation in the refractive index of the optical material. The periodic variation in refractive index creates planes of peak refractive index, i.e., volume grating structure, within the optical element. The volume grating structure diffracts the light entering the HOE and, thus, the path of the light is modified and redirected to a desired direction. FIG. 1 illustrates the present invention with a corrective ophthalmic lens 10 for hyperopia. The lens 10 is an HOE which has a pattern of interference fringes 12. The pattern of interference fringes 12 directs the light 14, which enters the lens 10 from one side, to be focused to a focal point 16, which is located on the other side of the lens 10. In accordance with the present invention, the incoming light 14 preferably is diffracted by more than one interference fringe 12 and redirected to the focal point 16.

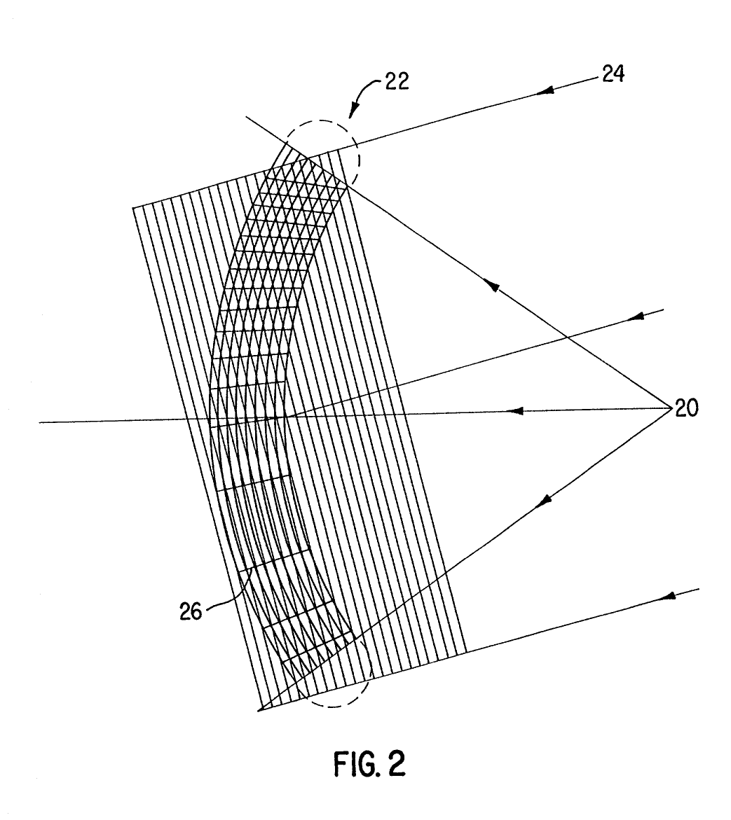

An exemplary process for producing an HOE of the present invention is illustrated in FIG. 2. HOEs suitable for the present invention can be produced, for example, from polymerizable or crosslinkable optical materials and photographic hologram recording media. Suitable optical materials are further discussed below. Hereinafter, for illustration purposes, the term “polymerizable materials” is used to indicate both polymerizable materials and crosslinkable materials, unless otherwise indicated. Point-source object light 20 is projected to a photopolymerizable optical material (i.e., photopolymerizable HOE) 22, and collimated reference light 24 is simultaneously projected to the photopolymerizable HOE 22 such that the electromagnetic waves of the object light 20 and the reference light 24 form interference fringe patterns, which are recorded in the polymerizable optical material as it is polymerized. The photopolymerizable HOE 22 is a photopolymerizable material that is polymerized by both the object light and the reference light. Preferably, the object light and the reference light are produced from one collimated light source using a beam splitter. The two split portions of the light are projected toward the HOE 22, in which the path of the object light portion of the split light is modified to form a point-source light 24. The point-source object light 24 is provided, for example, by placing a conventional convex optical lens some distance away from the photopolymerizable HOE 22 such that one portion of the split light is focused on a desirable distance away from the HOE 22, i.e., on the point-source light position 20 of FIG. 2. A preferred light source is a laser source, more preferred is a U.V. laser source. Although the suitable wavelength of the light source depends on the type of HOE employed, preferred wavelength ranges are between 300 nm and 600 nm. When the photopolymerizable HOE 22 is fully exposed and polymerized, the resulting HOE contains a recorded pattern of interference fringes (i.e., volume grating structure 26). The polymerized HOE 22 has a focal point 20 which corresponds to the position of the point-source object light 20 when light enters the HOE from the opposite side of the focal point. In accordance with the present invention, the power of the ophthalmic lens can be changed, for example, by changing the distance and position of the object light 20. FIG. 2 provides an exemplary method for producing an HOE having a positive corrective power. As can be appreciated, HOEs having a negative corrective power can also be produced with the above-described HOE production set up with some modifications. For example, a convergent object light source that forms a focal point on the other side of the HOE away from the light source can be used in place of the point-source object light to produce an HOE having a negative corrective power. Similarly, other correctional needs can be accommodated by changing the configuration or pattern of the object and reference light sources, e.g., the HOE can be programmed to have corrective measures for the unequal and distorted corneal curvature of an irregular astigmatic condition by specifically designing the configurations of the object light and the reference light.

As discussed above, suitable HOEs can be produced from polymerizable or crosslinkable optical materials that can be relatively rapidly photopolymerized or photocrosslinked. A rapidly polymerizable optical material allows a refractive index modulation can be formed within the optical material, thereby forming the volume grating structure, while the material is being polymerized to form a solid optical material. Exemplary polymerizable optical materials suitable for the present invention are disclosed in U.S. Pat. No. 5,508,317 to Beat Müller and International Patent Application No. PCT/EP96/00246 to Mülebach, which patent and patent application are herein incorporated by reference and further discussed below. A preferred group of polymerizable optical materials, as described in U.S. Pat. No. 5,508,317, are those that comprise a 1,3-diol basic structure in which a certain percentage of the 1,3-diol units have been modified to a 1,3-dioxane having in the 2-position a radical that is polymerizable but not polymerized. The polymerizable optical material is preferably a derivative of a polyvinyl alcohol having a weight average molecular weight, M_{w}, of at least about 2,000 that, based on the number of hydroxy groups of the polyvinyl alcohol, comprises from about 0.5% to about 80% of units of formula I:

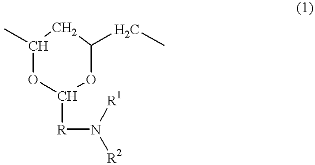

wherein:

R is lower alkylene having up to 8 carbon atoms,

R¹ is hydrogen or lower alkyl and

R² is an olefinically unsaturated, electron-attracting, copolymerizable radical preferably having up to 25 carbon atoms. R² is, for example, an olefinically unsaturated acyl radical of formula R³—CO—, in which

R³ is an olefinically unsaturated copolymerizable radical having from 2 to 24 carbon atoms, preferably from 2 to 8 carbon atoms, especially preferably from 2 to 4 carbon atoms.

In another embodiment, the radical R² is a radical of formula II

—CO—NH—(R⁴—NH—CO—)_{q}—R⁵—O—CO—R³ (II)

wherein

q is zero or one; R⁴ and R⁵ are each independently lower alkylene having from 2 to 8 carbon atoms, arylene having from 6 to 12 carbon atoms, a saturated divalent cycloaliphatic group having from 6 to 10 carbon atoms, arylenealkylene or alkylenearylene having from 7 to 14 carbon atoms, or arylenealkylenearylene having from 13 to 16 carbon atoms; and R³ is as defined above.

Lower alkylene R preferably has up to 8 carbon atoms and may be straight-chained or branched. Suitable examples include octylene, hexylene, pentylene, butylene, propylene, ethylene, methylene, 2-propylene, 2-butylene and 3-pentylene. Preferably lower alkylene R has up to 6 and especially preferably up to 4 carbon atoms. Methylene and butylene are especially preferred. R¹ is preferably hydrogen or lower alkyl having up to seven, especially up to four, carbon atoms, especially hydrogen.

As for R⁴ and R⁵, lower alkylene R⁴ or R⁵ preferably has from 2 to 6 carbon atoms and is especially straight-chained. Suitable examples include propylene, butylene, hexylene, dimethylethylene and, especially preferably, ethylene. Arylene R⁴ or R⁵ is preferably phenylene that is unsubstituted or is substituted by lower alkyl or lower alkoxy, especially 1,3-phenylene or 1,4-phenylene or methyl-1,4-phenylene. A saturated divalent cycloaliphatic group R⁴ or R⁵ is preferably cyclohexylene or cyclohexylene-lower alkylene, for example cyclohexylenemethylene, that is unsubstituted or is substituted by one or more methyl groups, such as, for example, trimethylcyclohexylenemethylene, for example the divalent isophorone radical. The arylene unit of alkylenearylene or arylenealkylene R⁴ or R⁵ is preferably phenylene, unsubstituted or substituted by lower alkyl or lower alkoxy, and the alkylene unit thereof is preferably lower alkylene, such as methylene or ethylene, especially methylene. Such radicals R⁴ or R⁵ are therefore preferably phenylenemethylene or methylenephenylene. Arylenealkylenearylene R⁴ or R³ is preferably phenylene-lower alkylene-phenylene having up to 4 carbon atoms in the alkylene unit, for example phenyleneethylenephenylene. The radicals R⁴ and R⁵ are each independently preferably lower alkylene having from 2 to 6 carbon atoms, phenylene, unsubstituted or substituted by lower alkyl, cyclohexylene or cyclohexylene-lower alkylene, unsubstituted or substituted by lower alkyl, phenylene-lower alkylene, lower alkylene-phenylene or phenylene-lower alkylene-phenylene.

The polymerizable optical materials of the formula I be produced, for example, by reacting a polyvinylalcohol with a compound III,

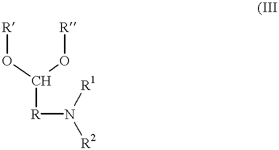

wherein R, R¹ and R² are as defined above, and R′ and R″ are each independently hydrogen, lower alkyl or lower alkanoyl, such as acetyl or propionyl. Desirably, between 0.5 and about 80% of the hydroxyl groups of the resulting the polymerizable optical material are replaced by the compound III.

Another group of exemplary polymerizable optical materials suitable for the present invention is disclosed in International Patent Application No. PCT/EP96/00246 to Mühlebach. Suitable optical materials disclosed therein include derivatives of a polyvinyl alcohol, polyethyleneimine or polyvinylamine which contains from about 0.5 to about 80%, based on the number of hydroxyl groups in the polyvinyl alcohol or the number of imine or amine groups in the polyethyleneimine or polyvinylamine, respectively, of units of the formula IV and V:

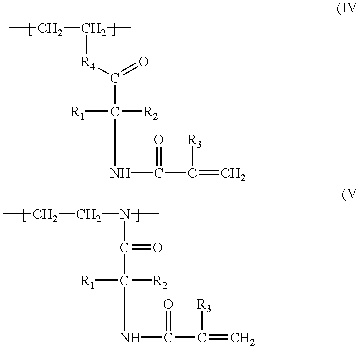

wherein R₁ and R₂ are, independently of one another, hydrogen, a C₁-C₈ alkyl group, an aryl group, or a cyclohexyl group, wherein these groups are unsubstitued or substituted; R₃ is hydrogen or a C₁-C₈ alkyl group, preferably is methyl; and R₄ is an —O— or —NH— bridge, preferably is —O—. Polyvinyl alcohols, polyethyleneimines and polyvinylamines suitable for the present invention have a number average molecular weight between about 2000 and 1,000,000, preferably between 10,000 and 300,000, more preferably between 10,000 and 100,000, and most preferably 10,000 and 50,000. A particularly suitable polymerizable optical material is a water-soluble derivative of a polyvinyl alcohol having between about 0.5 to about 80%, preferably between about 1 and about 25%, more preferably between about 1.5 and about 12%, based on the number of hydroxyl groups in the polyvinyl alcohol, of the formula III that has methyl groups for R₁ and R₂, hydrogen for R₃, —O— (i.e., an ester link) for R₄.

The polymerizable optical materials of the formulae IV and V can be produced, for example, by reacting an azalactone of the formula VI,

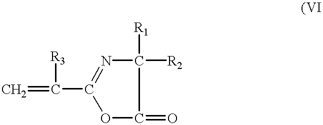

wherein R₁, R₂ and R₃ are as defined above, with a polyvinyl alcohol, polyethyleneimine or polyvinylamine at elevated temperature, between about 55° C. and 75° C., in a suitable organic solvent, optionally in the presence of a suitable catalyst. Suitable solvents are those which dissolve the polymer backbone and include aproctic polar solvents, e.g., formamide, dimethylformamide, hexamethylphosphoric triamide, dimethyl sulfoxide, pyridine, nitromethane, acetonitrile, nitrobenzene, chlorobenzene, trichloromethane and dioxane. Suitable catalyst include tertiary amines, e.g., triethylamine, and organotin salts, e.g., dibutyltin dilaurate.

Another group of HOEs suitable for the present invention can be produced from conventional transmission volume holographic optical element recording media. As with the above-described polymerizable material, Point-source object light and collimated reference light are simultaneously projected onto an HOE recording medium such that the electromagnetic waves of the object and reference light form interference fringe patterns. The interference fringe pattern is recorded in the HOE medium. When the HOE recording medium is fully exposed, the recorded HOE medium is developed in accordance with a known HOE developing method. The developed HOE has a focal point that corresponds to the location of the point-source object light. Suitable transmission volume holographic optical element recording media include commercially available holographic photography recording materials or plates, such as dichromatic gelatins. Holographic photography recording media are available from various manufacturers, including Polaroid Corp.

When photographic recording media are used for the HOE of ophthalmic lenses, however, the presence of toxicological effects of the media on the ocular environment must be considered. Accordingly, when a conventional photographic HOE medium is used, it is preferred that the HOE be encapsulated in a biocompatible optical material. Suitable biocompatible optical materials include polymeric and non-polymeric optical materials that are useful for producing contact lenses, e.g., hard lenses, rigid gas permeable lenses and hydrogel lenses. Suitable hydrogel materials for hydrogel contact lenses typically have a cross-linked hydrophilic network and hold between about 35% and about 75%, based on the total weight of the hydrogel material, of water. Examples of suitable hydrogel materials include copolymers having 2-hydroxyethyl methacrylate and one or more comonomers such as 2-hydroxy acrylate, ethyl acrylate, methyl methacrylate, vinyl pyrrolidone, N-vinyl acrylamide, hydroxypropyl methacrylate, isobutyl methacrylate, styrene, ethoxyethyl methacrylate, methoxy triethyleneglycol methacrylate, glycidyl methacrylate, diacetone acrylamide, vinyl acetate, acrylamide, hydroxytrimethylene acrylate, methoxy methyl methacrylate, acrylic acid, methacrylic acid, glyceryl ethacrylate and dimethylamino ethyl acrylate. Other suitable hydrogel materials include copolymers having methyl vinyl carbazole or dimethylarnino ethyl methacrylate. Another group of suitable hydrogel materials include crosslinkable materials that are disclosed in U.S. Pat. No. 5,508,317, issued to Beat Müller, which is discussed above. Yet another group of highly suitable hydrogel materials include silicone copolymers disclosed in International Patent Application No. PCT/EP96/01265. Suitable rigid gas permeable materials for the present invention include cross-linked siloxane polymers. The network of such polymers incorporates appropriate cross-linkers such as N,N′-dimethyl bisacrylamide, ethylene glycol diacrylate, trihydroxy propane triacrylate, pentaerythtritol tetraacrylate and other similar polyfunctional acrylates or methacrylates, or vinyl compounds, e.g., N-methylamino divinyl carbazole. Suitable rigid materials include acrylates, e.g., methacrylates, diacrylates and dimethacrylates, pyrolidones, styrenes, amides, acrylamides, carbonates, vinyls, acrylonitrieles, nitriles, sulfones and the like. Of the suitable materials, hydrogel materials are particularly suitable for the present invention.

An encapsulated ophthalmic lens of the present invention containing a photographic HOE can be produced by fabricating an HOE containing a volume grating structure in accordance with the present invention, which HOE preferably has a sheet or thin disk or shell shape; placing the HOE in a biocompatible optical material; and then polymerizing the biocompatible optical material to form an encapsulated composite lens. The encapsulating and polymerizing steps can be conducted in a lens mold such that a fully formed composite lens is produced. As another embodiment, a button or block of an HOE-containing composite material is formed and then shaped to an ophthalmic lens using a lathing apparatus. As yet another embodiment, two layers of a polymerized biocompatible optical material can be laminated over both sides of a volume grating structure -containing HOE to form a composite ophthalmic lens of the present invention.

In accordance with the present invention, suitable HOEs preferably have a diffraction efficiency of at least about 75%, more preferably at least about 80%, most preferably at least 95%, over all or substantially all wavelengths within the visible spectrum of light. Especially suitable HOEs for the present invention have a diffraction efficiency of 100% over all wavelengths of the spectrum of visible light when the Bragg condition is met. The Bragg condition is well known in the optics art, and it is, for example, defined in Coupled Wave Theory for Thick Hologram Gratings, by H. Kogelnik, The Bell System Technical Journal, Vol. 48, No. 9, p 2909-2947 (Nov. 1969). The description of the Bragg condition disclosed therein is incorporated by reference. HOEs having a lower diffraction efficiency than specified above can also be utilized for the present invention.

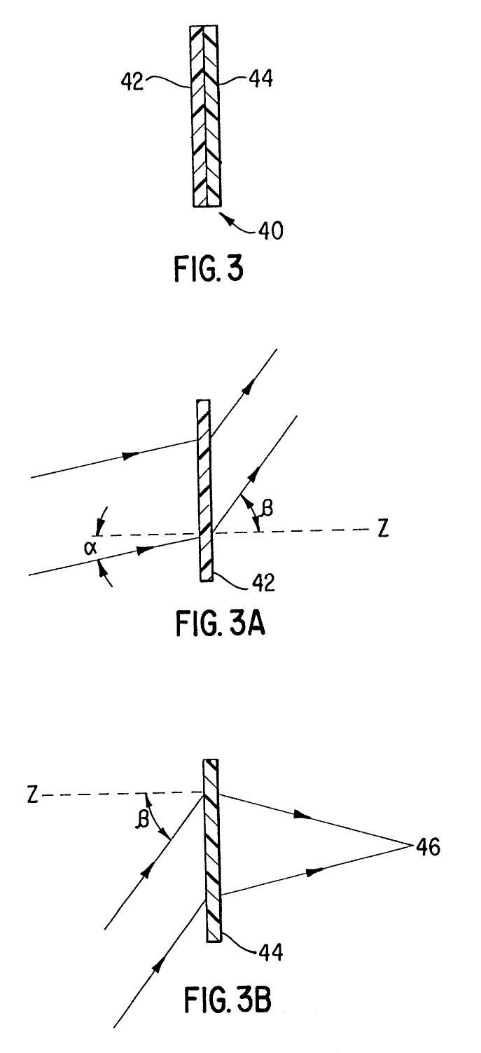

Suitable HOEs for the present invention preferably are multilayer combination HOEs having at least two layers of HOEs since layering thin HOEs improves the diffractive efficiency and the optical quality of the HOE and enables the thickness of the HOE to be reduced. As is known in the ophthalmic art, an ophthalmic lens should have a thin dimensional thickness to promote comfort of the lens wearer. Accordingly, a dimensionally thin HOE is preferred for the present invention. However, in order to provide an HOE having a high diffractive efficiency, the HOE has to be optically thick, i.e., the light is diffracted by more than one plane of the interference fringe pattern. One way to provide an optically thick and dimensionally thin HOE is programming the interference fringe pattern in a direction that is slanted towards the length of the HOE. Such slanted volume grating structure renders the HOE to have a large angular deviation between the incident angle of the incoming light and the exiting angle of the exiting light. However, an HOE having a large angular deviation may not be particularly suitable for an ophthalmic lens. For example, when such an HOE is placed on the eye, the line of sight is significantly bent away from the normal line of sight of the eye. As a preferred embodiment of the present invention, this angular limitation in designing an HOE is addressed by utilizing a multilayer combination HOE, especially a bilayer HOE. FIG. 3 illustrates an exemplary combination HOE 40 of the present invention. Two dimensionally thin HOEs having a large angular deviation are fabricated into a combination HOE to provide a dimensionally thin HOE that has a small angular deviation. The multilayer HOE 40 has a dimensionally thin first HOE 42 and a thin second HOE 44. The first HOE 42 is programmed to diffract the incoming light such that when light enters the HOE at an angle α, the light exiting the HOE 42 forms an exiting acute angle β, which is larger than the incident angle α, as shown in FIG. 3A. Preferably, the first HOE has a thickness between about 10 μm and about 100 μm, more preferably between about 20 μm and about 90 μm, most preferably between about 30 μm and about 50 μm. The second HOE 44, FIG. 3B, is programmed to have a activating incident angle β that matches the exiting angle β of the first HOE 42. In addition, the second HOE 44 is programmed to focus the incoming light to a focal point 46 when the light enters within the activating angle β. FIG. 3B illustrates the second HOE 44. Preferably, the second HOE has a thickness between about 10 μm and about 100 μm, more preferably between about 20 μm and about 90 μm, most preferably between about 30 μm and about 50 μm.

When the first HOE 42 is placed next to the second HOE 44 and the incoming light enters the first HOE 42 at an angle that corresponds to the angle α, the path of the light exiting the combination HOE 40 is modified and the light is focused to the focal point 46. By utilizing a multilayer combination HOE, a dimensionally thin HOE having a high diffractive efficiency and a small angular deviation can be produced. In addition to the high diffractive efficiency and small angular deviation advantages, utilizing a multilayer HOE provides other additional advantages, which include correction of dispersion aberration and chromatic aberration. A single HOE may produce images having dispersion and chromatic aberrations since visual light consists of a spectrum of electromagnetic waves having different wave lengths and the differences in wavelengths may cause the electromagnetic waves to diffract differently by the HOE. It has been found that a multilayer, especially bilayer, HOE can counteract to correct these aberrations that may be produced by a single layer HOE. Accordingly, a multilayer combination HOE is preferred.

The ophthalmic lens production method of the present invention is a highly flexible method that can be used to produce ophthalmic lenses having a wide range of corrective powers and that produces ophthalmic lenses that are designed to promote the comfort of the lens wearer. Unlike conventional ophthalmic lenses, the correctional power or powers of the present ophthalmic provides the corrective power or powers by programming suitable powers into the lens, even without the need for changing dimensions of the lens. In addition, the manufacturing set up does not have to be changed substantially when the set up is changed to produce lenses having different corrective powers. As discussed above, different corrective powers can be programmed into the ophthalmic lens by, for example, changing the distance, pattern and/or configuration of the object light and the reference light. Accordingly, the lens production process is highly simplified. Additional advantages include the fact that ophthalmic lens manufacturers do not need to have different lens manufacturing equipment and methods to produce a wide range of different lenses having different corrective powers. Accordingly, ophthalmic lens manufacturers do not need to produce and carry a large number of different ophthalmic lenses having different configurations and/or dimensions.

It is to be noted that although the present invention is described in conjunction with ophthalmic lenses, corrective spectacle lenses having a volume HOE can be produced in accordance with the present invention. For example, a dimensionally thin film of an HOE, which is programmed to provide a corrective power, can be laminated on a plano spectacle lens. Such spectacle lenses, i.e., eyeglass lenses, can be designed to promote the comfort of the wearer without sacrificing the corrective efficacy of the lenses since the corrective HOE lens does not rely on the thickness of the lens to provide the corrective power, as discussed above.

The present invention is further illustrated with the following example. However, the example is not to be construed as limiting the invention thereto.

### EXAMPLE

About 0.06 ml of the Nelfilcon A lens monomer composition is deposited in the center portion of a female mold half, and a matching male mold half is placed over the female mold half, forming a lens mold assembly. The lens mold is designed to produce a plano lens. The male mold half does not touch the female mold half, and they are separated by about 0.1 mm. The lens mold halves are made from quartz and are masked with chrome, except for the center circular lens portion of about 15 mm in diameter. Briefly, Nelfilcon A is a product of a crosslinkable modified polyvinyl alcohol which contains about 0.48 mmol/g of an acryamide crosslinker. The polyvinyl alcohol has about 7.5 mol % acetate content. Nelfilcon A has a solid content of about 31% and contains about 0.1% of a photoinitiator, Durocure® 1173. The closed lens mold assembly is placed under a laser set up. The laser set up provides two coherent collimated U.V. laser beams having 351 nm wavelength, in which one beam is passed through a optical convex lens so that the focal point is formed at 500 mm away from the lens mold assembly. The focused light serves as a point-source object light. The angle formed between the paths of the object light and the reference light is about 7°. The set up provides an HOE that is programmed to have a corrective power of 2 diopters. The lens monomer composition is exposed to the laser beams having about 0.2 watts for about 2 minutes to completely polymerize the composition and to form interference fringe patterns. Since the lens mold is masked except for the center portion, the lens monomer exposed in the circular center portion of the mold is subjected to the object light and the reference light and polymerized.

The mold assembly is opened, leaving the lens adhered to the male mold half. About 0.06 ml of the Nelfilcon A lens monomer composition is again deposited in the center portion of the female mold half, and the male mold half with the adhered lens is placed over the female mold half. The male and female mold halves are separated by about 0.2 mm. The closed mold assembly is again exposed to the laser set up, except that the optical convex lens is removed from the object light set up. The monomer composition is again exposed to the laser beams for about 2 minutes to completely polymerize the composition and to form a second layer of interference fringe patterns. The resulting composite lens has an optical power of +2 diopters.

What is claimed is:

1. A method for producing an optical lens for correcting ametropic conditions, said lens having a front curve and a base curve, which method comprises the steps of:
a) introducing a polymerizable optical material in a mold for an optical lens; and
b) exposing said polymerizable material in said mold to electromagnetic waves, wherein said electromagnetic waves form a pattern of interference fringes while polymerizing said polymerizable material, thereby said pattern is recorded in said lens to form a volume grating structure, thereby forming a volume holographic element,
wherein said pattern diffracts light entering said front curve to correct said ametropic conditions when placed on, in or in front of an eye.

2. The method of claim 1 wherein said method further comprises the steps of providing an additional layer polymerizable optical material and exposing said polymerizable material to electromagnetic waves such that said lens forms a combination volume holographic element.

3. The method of claim 1 wherein said electromagnetic waves are laser beams.

4. The method of claim 3 wherein said laser means are U.V. laser beams.

5. The method of claim 1 wherein said method is adapted to produce an ophthalmic lens.

6. A lens produced from the method of claim 1.

7. A flexible method for producing a optical lens having a corrective power, comprising the steps of:
a) introducing a polymerizable optical material in a mold for an optical lens; and
b) exposing said polymerizable material in said mold to a pattern of electromagnetic waves, said electromagnetic waves polymerizing said optical material and said pattern imparting a volume grating structure in said ophthalmic lens as it is being polymerized, thereby forming a volume holographic element,
wherein said volume grating structure is adapted to provide said corrective power of said optical lens when said optical lens is placed on, in or in front of a mammalian eye.

8. The method of claim 7 wherein said method further comprises the steps of providing an additional layer polymerizable optical material and exposing said polymerizable material to electromagnetic waves such that said lens forms a combination volume holographic element.

9. The method of claim 7 wherein said electromagnetic waves are laser beams.

10. The method of claim 9 wherein said laser means are U.V. laser beams.

11. The method of claim 7 wherein said method is adapted to produce an ophthalmic lens.

12. A lens produced from the method of claim 7.

13. A method for producing an ophthalmic lens for correcting ametropic conditions, said lens having a front curve and a base curve, which method comprises the steps of:
a) exposing a holographic recording medium to electromagnetic waves, wherein said electromagnetic waves form a pattern of interference fringes of a volume grating structure and said pattern is designed to diffract light entering said front curve to at least partially correct said ametropic conditions,
b) developing the exposed holographic recording medium, and
c) encapsulating the developed recording medium in a biocompatible optical material, thereby forming said optical lens.

14. The method of claim 13 wherein said method further comprises the step of providing an additional layer of an exposed holographic recording medium such that said recording medium forms a combination volume holographic element.

15. The method of claim 13 wherein said electromagnetic waves are laser beams.

16. The method of claim 15 wherein said laser means are U.V. laser beams.

17. The method of claim 13 wherein said method is adapted to produce an ophthalmic lens.

18. A lens produced from the method of claim 13.

19. A method for producing a lens for correcting ametropic conditions of an eye, said lens having a front curve and a base curve, which method comprises the steps of:
a) introducing a polymerizable optical material in a mold for an optical lens; and
b) exposing said polymerizable material in said mold to electromagnetic waves, wherein said electromagnetic waves form a pattern of interference fringes while polymerizing said polymerizable material, thereby a volume grating structure is formed in said lens,
wherein said pattern modifies light entering said lens to correct said ametropic conditions.

20. The method of claim 19 wherein said volume grating structure forms a volume holographic element and said method further comprises the steps of providing an additional layer polymerizable optical material and exposing said polymerizable material to electromagnetic waves such that said lens forms a combination volume holographic element.

21. The method of claim 19 wherein said electromagnetic waves are laser beams.

22. The method of claim 21 wherein said laser means are U.V. laser beams.

23. The method of claim 19 wherein said method is adapted to produce an ophthalmic lens.

24. A lens produced from the method of claim 19.
